(19) United States
(12) Patent Application Publication
(10) Pub. No.: US 2022/0405862 A1
(43) Pub. Date: Dec. 22, 2022

(54) SYSTEM FOR USERS TO INCREASE AND MONETIZE LIVESTREAM AUDIENCE ENGAGEMENT

(71) Applicant: Lakshmanan Narayan, Basking Ridge, NJ (US)

(72) Inventors: Lakshmanan Narayan, Basking Ridge, NJ (US); Lakyntina L. Lakshmanan, Basking Ridge, NJ (US); Joseph Varghese, Long Grove, IL (US); Ram Gupta, Sunnyvale, CA (US)

(21) Appl. No.: 17/844,011

(22) Filed: Jun. 19, 2022

Related U.S. Application Data
(60) Provisional application No. 63/212,700, filed on Jun. 20, 2021.

(51) Int. Cl. G06Q 50/00

(52) U.S. Cl. CPC G06Q 50/01

(57) ABSTRACT

A method and system for engaging an audience in a livestreaming session is disclosed. The method includes aggregating the audience's data in the livestream session. The method further includes processing the audience's data. The method may further include recommending interventions during the livestream session to a host based on the audience's data.

### TECHNOLOGICAL FIELD

The present invention relates to enhancing audience engagement in a livestream session. More specifically the invention analyzes audience behaviors in real time and based on the analysis provides tools to engage the audience. The invention seamlessly integrates with the livestreaming application and enhances user experience without taking the audience away from the livestreaming application. The present application claims the benefit of provisional application U.S. 63/212,700 the contents of which are herein incorporated by reference in its entirety.

### BACKGROUND

Many hosts regularly use livestreams to connect with their students, followers, buyers, or fans. Various kinds of livestreaming solutions already exist, for instance YouTube, Zoom, Facebook Live, Amazon Live, Livestream.com. However, in an existing livestreaming application, the audience engagement is poor. Hosts are overwhelmed by the comments in a livestream and it is impossible for the host to read the comments every few seconds. Hence, most of the comments are ignored. For example, the comments feed may have many questions from the audience that the host would miss. And since the questions were not answered the audience might feel disengaged with the livestream session. Therefore, there is a need for analyzing and enhancing the engagement of the audience in real-time.

Also, there is an unmet need of improving audience engagement that can recommend to the host to pause and engage audience, using means such as—1) answer audience questions, in case of lot of questions, 2) if the audience are bored, introduce ice breaking exercises. 3) And many more such instances.

There are some existing solutions that provide ice breaking exercises tools during the livestreaming session. However, the existing solutions do not provide seamless integration with the livestream application and takes the audience away from the livestreaming platform. Furthermore, the existing solutions do not scale in analyzing a large audience and engaging them in real time.

### BRIEF SUMMARY

In one embodiment, a method of engaging an audience is disclosed. The method includes aggregating the audience's data in the livestream session, processing the audience's data and recommending interventions during the livestream session to a host based on the audiences' data.

In another embodiment, a system of engaging an audience is disclosed. The system aggregates the audience's data in the livestream session, processes the audience's data and recommends interventions during the livestream session to a host based on the audience's data.

It is to be understood that both the foregoing general description and the following detailed description are exemplary and explanatory only and are not restrictive of the invention, as claimed.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a system to increase and monetize audience engagement in a livestream in accordance with an example embodiment;

FIG. 2 illustrates a block diagram of an overview of a presenter and a user interacting with the system, in accordance with an example embodiment;

FIG. 3 illustrates an exemplary example of live performance of the system, in accordance with one or more example embodiments;

FIG. 4 illustrates an exemplary functional abstraction of the system, in accordance with one or more example embodiments;

FIG. 5 illustrates an exemplary flowchart of the system under operation, in accordance with one or more example embodiments;

FIG. 6 illustrates block diagram for a read operation of the system, in accordance with an example embodiment;

FIG. 7 illustrates an exemplary example flow chart of a read process for YouTube application, in accordance with an example embodiment;

FIG. 8 illustrates a flowchart to build and update an engagement model, in accordance with an example embodiment;

FIG. 9 illustrates a block diagram for an engagement and recommendation model, in accordance with an example embodiment;

FIG. 10 illustrates a map model, in accordance with an example embodiment;

FIG. 11 illustrates an operation of a map model, in accordance with an example embodiment;

FIG. 12 illustrates a keyword model, in accordance with an example embodiment; and

FIG. 13 illustrates an operation of a keyword model, in accordance with an example embodiment.

FIG. 14 illustrates a flow diagram of a lead generation model, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

Exemplary embodiments are described with reference to the accompanying drawings. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. This invention executes over a networked computing system. The computing system is composed of at least a processor, memory, input/output system and is networked with other computing systems. The processor may be disposed in communication with one or more input/output (I/O) devices via an I/O interface I/O interface may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like), etc.

In some embodiments, processor may be disposed in communication with a communication network via a network interface. Network interface may communicate with communication network. Network interface may employ connection protocols including, without limitation, direct connect, Ethernet (e.g., twisted pair 50/500/5000 Base T), transmission control protocol/internet protocol (TCP/IP), token ring, IEEE 802.11a/b/g/n/x, etc.

Communication network may include, without limitation, a direct interconnection, local area network (LAN), wide area network (WAN), wireless network (e.g., using Wireless Application Protocol), the Internet, etc. Using network interface and communication network 614, computer system may communicate with devices. These devices may include, without limitation, personal computer(s), server(s), fax machines, printers, scanners, various mobile devices such as cellular telephones, smartphones.

In some embodiments, processor may be disposed in communication with one or more memory devices (e.g., RAM, ROM, etc.) via a storage interface. Storage interface may connect to memory including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

The specification has described system and engaging an audience in a livestreaming session. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

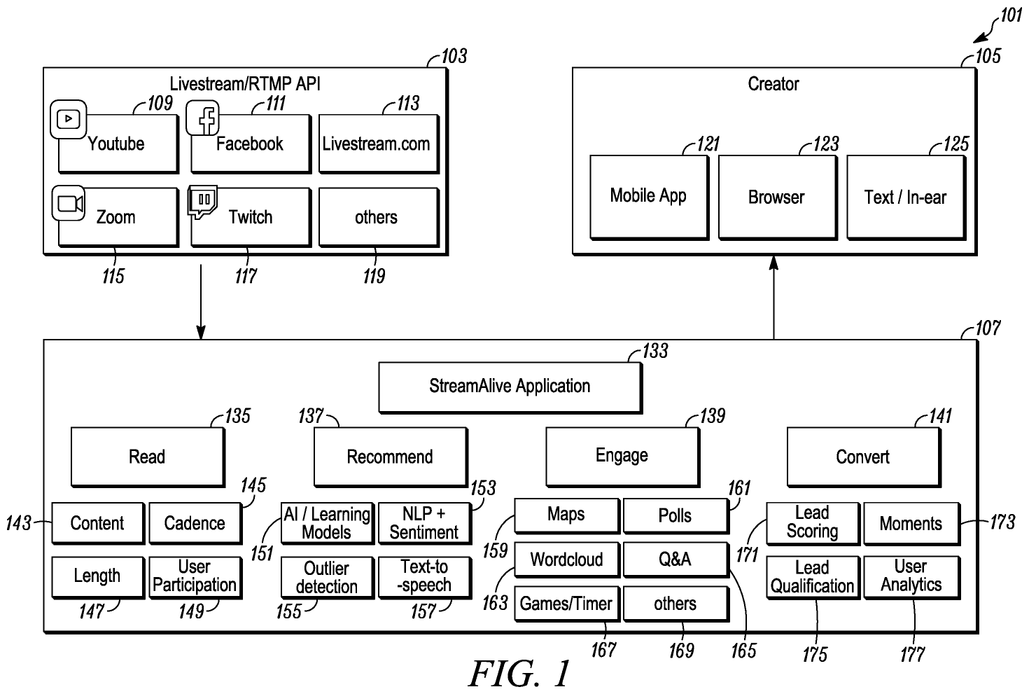

Referring now to FIG. 1, is a block diagram of an exemplary system 101 for engaging audience in a livestreaming session. The system comprises three components 1) Livestream/RTMP API 103, 2) A software executing on the machine (StreamAlive also known as WordsWorth Software) 107, and 3) a creator 105.

Livestream platforms can be, but are not limited to, YouTube 109, Facebook Live 111, Zoom 115, Twitch 117, Livestream.com 113 etc.

The StreamAlive software is a “software as a service (SaaS)” that comprises four modules 1) read 135, 2) recommend 137, 3) engage 139, and 4) convert 141.

Further, the read module 135 comprises of content 143, cadence 145, length 147 and user participation 149 submodules.

Also, the recommend module 137 includes but is not limited to AI/Learning 151, NLP+ Sentiment 153, outlier detection 155 and text-to-speech 157 submodules.

In addition, the engage module 139 further comprises of submodules maps 159, polls 161, word cloud 163, Q & A 165 and Games/Timer 167.

Further, the convert 141 module further comprises of lead scoring 171, lead qualification 175, moments 173 and user analytics 177 sub modules.

A host is sometimes referred to as a presenter, a livestreamer or a creator 105. It is understood that the mentioned terms are not limiting in nature.

Typically, the creator 105 can engage with the audience through a mobile app 121, a browser 123 or audio 125. However, there are other means of engagement and the said means are meant to serve as illustrative examples and should not be construed as limiting.

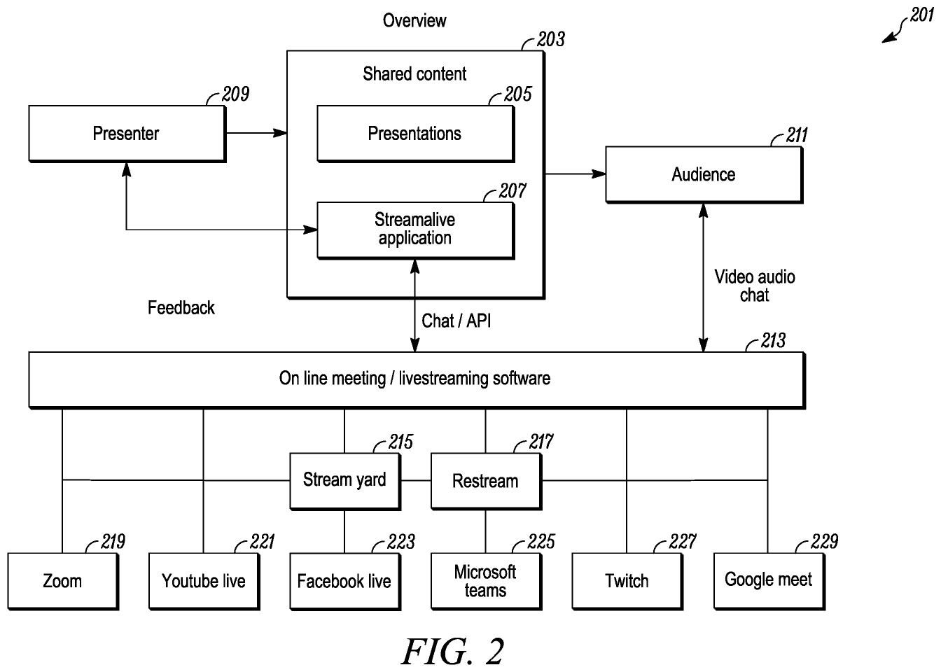

Referring to FIG. 2 a block diagram 201 is presented which is an overview of a presenter 209 and an audience 211 also termed as a user interacting with the system.

The presenter 209 uses shared content 203 which further comprises of presentations 205 and the StreamAlive application 207. Further, the presenter 209 shows or relays presentations 205 to an audience 211 and simultaneously uses StreamAlive application 207 to enhance the engagement of the audience 211.

While the audience 211 is viewing the presentations 205 they can also interact with the presenter 209 via the chat interface provided by the online meeting/livestreaming software platform 213. The StreamAlive application 207 further captures the chat output of the audience and provides meaningful feedback to the presenter 209 who in turn can better engage with the audience 211.

The StreamAlive application 207 interfaces with several online meeting/livestreaming software 213 such as Stream yard 215, Restream 217, Zoom 219, YouTube live 221, Facebook live 223, Microsoft teams 225, Twitch 227 and Google meet 229. The mentioned online meeting/livestreaming software 213 are mentioned as example embodiments and should not be construed to be exhaustive or limiting in any way.

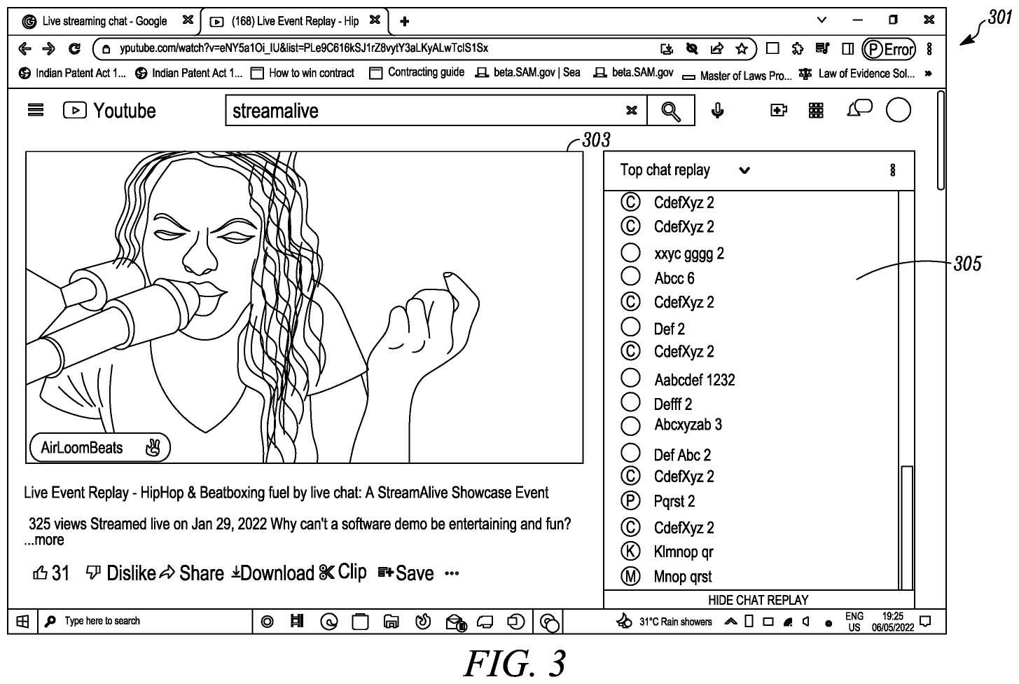

FIG. 3 illustrates an exemplary example of live performance of the system as presented to an audience 211. A session 301 is typically presented to an audience 211. The session 301 is further composed of a video or presentation 303 and a chat window 305 which is used by the audience 211 to interact with the presenter 209. The said arrangement is meant as an example embodiment and should not be construed as limiting in any way, there may be several means of operation which will be apparent to a person having ordinary skill in the area.

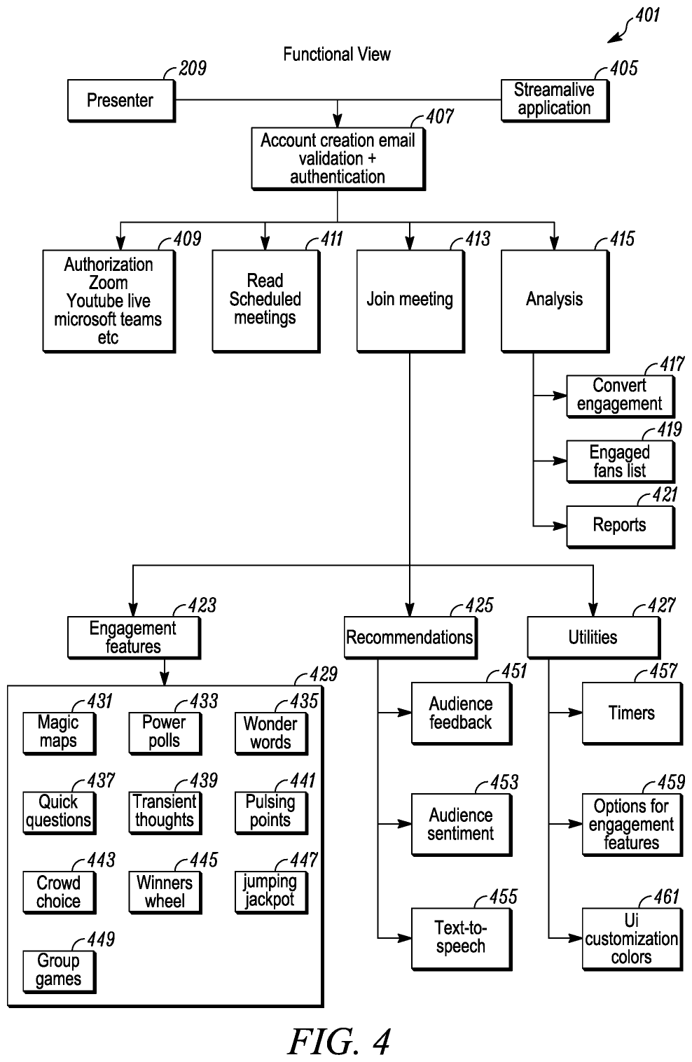

Referring to FIG. 4 an exemplary functional abstraction of the system is provided. A user 403 of the system is typically the presenter 209 in some embodiments installs StreamAlive application 405 and creates an account. An email validation and authentication 407 is performed on the account.

Further, the presenter 209 performs authorization step 409 on the online meeting/livestreaming software platform 213 which in some embodiments may be Zoom, YouTube live, Microsoft teams etc. In addition, the presenter 209 may read scheduled meetings 411, perform analysis 415 and join meetings 413.

A presenter 209 performs analysis 415 which include generating reports 421, producing an engaged fans list 419 and strives to convert engagement 417.

On joining a meeting 413 a presenter 209 in some embodiments is provided with the option of engagement features 423, recommendations 425, and utilities 427.

Engagement features 423 are tools provided by the StreamAlive application 207 for the purpose of enhancing the engagement of the audience 211. In some embodiments the engagement features 423 provided, but not limited are magic maps 431, power polls 433, wonder words 435, quick questions 437, transient thoughts 439, pulsing points 411, crowd choice 443, winners wheel 445, jumping jackpot 447 and group games 449. It is apparent that the engagement features 423 mentioned are not limiting in any way more features may be plugged in which are obvious to a person skilled in the art.

The recommendations 425 provided to the presenter 209 are in some embodiments audience feedback 451, audience sentiment 453 and text-to-speech 455. The recommendations 425 should not be construed to be limited to the ones mentioned.

Further, the utilities 427 provided to the presenter 209 but not limited to are timers 457, options for engagement features 459 and UI customizations 461.

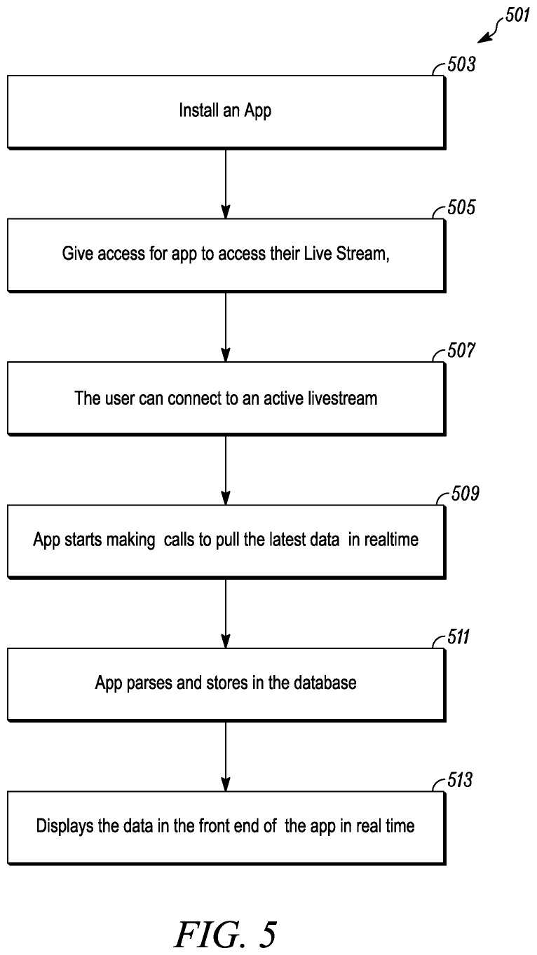

Referring now to FIG. 5 a flowchart of the system under operation 501, a presenter 209 installs the StreamAlive app 207 at step 503. The presenter 209 provides access to the livestream at 505. Further, an audience 211 is enabled to connect to an active livestream 507. A read module of the present invention reads the audience in a livestream session.

In a livestream, the audience typically comment in the chat box throughout the duration of the stream. The comments are live interactions related to location, questions, agreements, support, answers, appreciation, condemnation, opinion, requests, doubts, etc.

In real time, the invention pulls the comments data from any livestream platform (for examples, but not limited to, YouTube, Facebook Live, Zoom, Amazon Live, Livestream.com) as authorized 509. Further the data pulled is parsed and stored in a database 511. While latency is dependent on the livestream platform API's, the aim is to keep data latency to the minimum possible. It is important to note that the data is natively collected from the livestream to achieve minimum latency. In a next step StreamAlive application 207 displays data in the front-end UI in real-time 513.

In an embodiment, steps for reading a livestream for YouTube live. Initially create a YouTube app for StreamAlive 207 software in YouTube developer console and get approval to make it available publicly. The presenter 209 then logs in StreamAlive 207 software. Further, the presenter 209 will provide access to StreamAlive 207, the presenter's YouTube account to access livestream, using authorization (for e.g., Oauth2). The host sees a list of active livestreams in StreamAlive 207 software.

In other embodiments audience's 211 facial expressions, gestures and geolocation data can be pulled with their permission.

The presenter 209 can connect to an active livestream from the above list. Then the StreamAlive 207 software starts making API calls using presenter's 209 authorization token, where StreamAlive 207 software server programs will communicate with YouTube's API servers to get the latest data for the active livestream.

The StreamAlive 207 software will pull comments data (chat messages) for the connected livestream, where in some embodiments, StreamAlive 207 software will keep making calls every preset time interval to obtain new comments data in real time.

In an embodiment the data comes back in a JSON format and StreamAlive 207 parses the JSON formatted data and stores the information in the database, and then displays the data in the front-end of StreamAlive 207 app all in real time in certain embodiments with minimum latency.

In other embodiments similar steps of reading will be used for other livestream platforms, for example, but not limited to, Facebook Live, Amazon Live, Zoom webinars, Twitch, Life Church, and livestream.com.

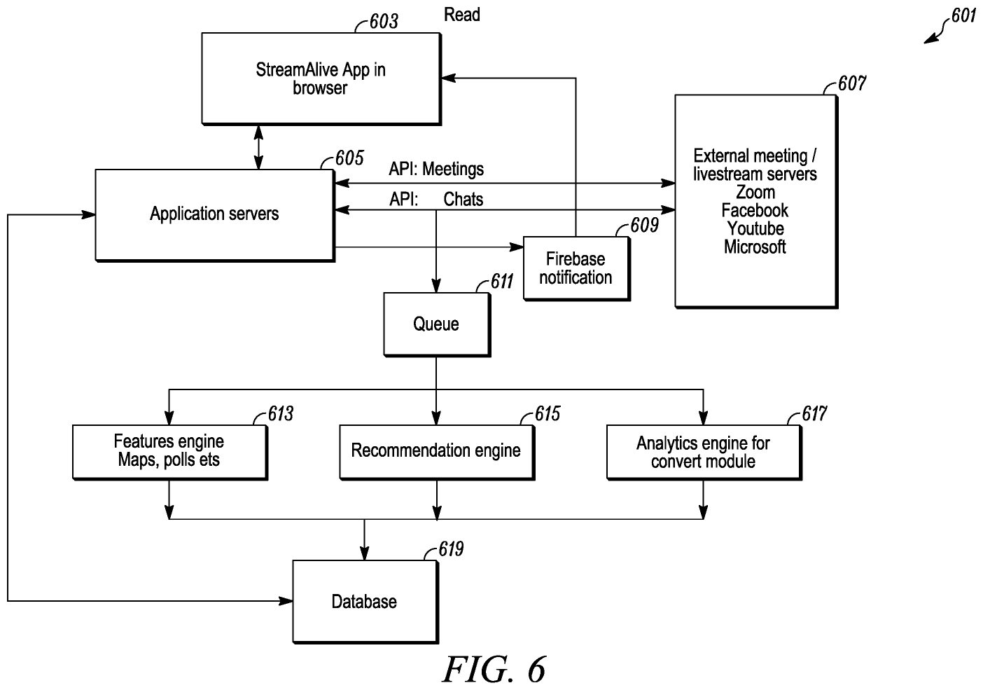

FIG. 6 illustrates a block diagram for a read operation 601. In some embodiments the StreamAlive App in browser 603 performs a two-way interaction with application servers 605 and receives messages from firebase notification 609.

The online meeting/livestream servers 607 of applications such as but not limited to Zoom, Facebook, YouTube and Microsoft, handle meetings and chat. The application servers 605 establish a two-way communication with the online meeting/livestream servers 607 through meetings and chat APIs.

A queue 611 interfaces with the chat API and further provides inputs to the recommendation engine 615, analytics engine for convert module 617 and features engine 613 for maps, polls etc. the outputs of the said engines are stored in a database 619.

The database 619 has a two communication with the application servers 605 wherein the chat data is stored in the database from the application servers 605. The engine's output is relayed back to the application servers 605 to be displayed through a firebase notification 609.

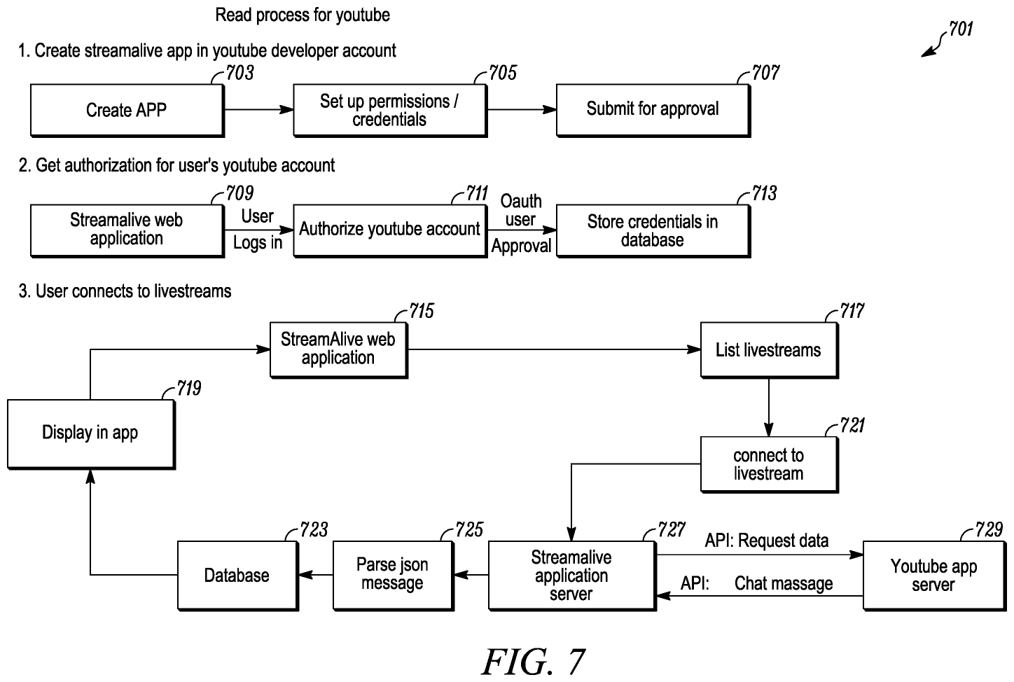

FIG. 7 illustrates an exemplary example flow chart of a read process for YouTube which can be further split into creating an account, obtaining authorization for the account and the interface with livestreams. In an example embodiment the presenter 209 creates a StreamAlive app 703 in YouTube developer account. In the next step permissions/credentials are set up 705 which is later submitted for approval 707.

In the obtaining authorization phase the presenter 209 logs into a StreamAlive web application 709 and authorizes YouTube account 711, further on approval stores credentials in database 713.

In the interface with livestreams phase the StreamAlive application server 727 requests data from the YouTube app server 729 through a request data API and the chat messages are relayed to the StreamAlive application server 727 via an API. At step 725 the chat messages in JSON format are parsed and stored in database 723 and is displayed in app 719. Further the messages are sent to the StreamAlive web application 715 which based on the list of livestreams 717 connects to the right livestream 721 which is coupled to the StreamAlive application server 727.

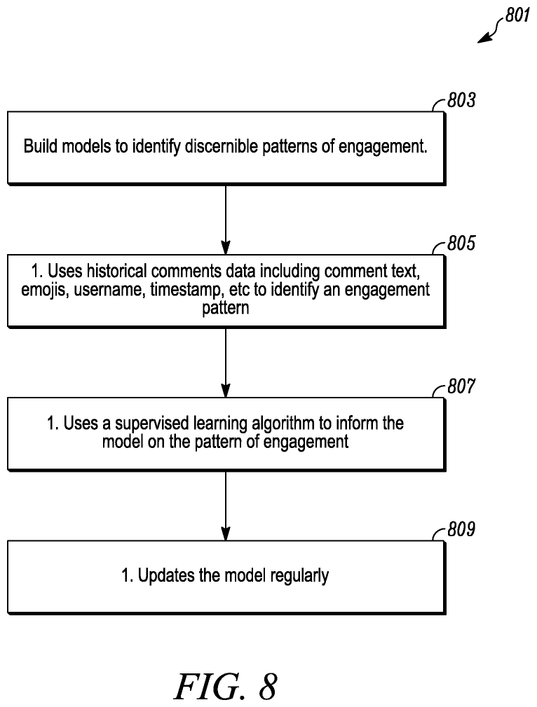

FIG. 8 illustrates a flowchart to build and update an engagement and a recommend module of the present invention. Also, recommends interventions to the presenter 209 to increase audience engagement.

In a first step models are built to identify discernable patterns of engagement 803. The data obtained from the read module is continuously fed into the ‘Recommend algorithm’ for continuous and real-time analyses. For building the model historical comments data which include text emojis, username timestamp is used to identify an engagement pattern 805. The recommend algorithm will analyze the data for engagement patterns, in real-time. Some of the potentially discernable patterns envisaged, but not limited to, are a bored audience, an excited audience, a puzzled /confused audience, a happy audience, a raucous audience or a serious audience.

For each change in pattern, the StreamAlive 207 software will send feedback to the host, and with specific recommendations to take a predetermined action. The feedback will be via a voice activated virtual assistant, piping into the earphones/headsets of the user. This takes advantage of the fact that in a “one to many” livestream, the host usually has their ears idle. They are obviously speaking and presenting but, more often than not, they are not listening to what hundreds (sometimes thousands) of people are saying. Hence, this idle sensory capacity is an opportunity to provide actionable feedback in livestream. In other embodiments the feedback may be via text, video or haptic.

The StreamAlive 207 software in some embodiments uses supervised learning algorithms to inform the model on the pattern of engagement 807. The supervised learning algorithms include but not limited to the AI/ML models, NLP+ algorithms, and outlier detection programs to detect changes in patterns and translate them into actionable recommendations. In certain embodiments AI/ML models may be but not limited to artificial neural networks and support vector machines. The model is updated regularly 809 to keep up with the current state of audience engagement.

Some of the actionable recommendations, but not limited to, are:
a. Pause, lots of questions. Address them
b. Pause, comments are slow. Run a poll
c. Pause, lots of irreverent comments. Ask a Question.
d. Pause, lots of appreciation. Acknowledge them.

The application uses a ‘text to speech’ program for the ‘voice activated feedback’.

Steps for building models to identify discernible patterns of engagement.
a. For each Engagement Pattern (hereafter EP) model, StreamAlive 207 software uses historical comments data including but not limited to comment text, emojis, username, timestamp to identify a pattern.
b. StreamAlive 207 software uses a supervised learning algorithm to inform the model on the pattern of engagement, using algorithms like, but not limited to, Representational learning or Generative Adversarial network. In other embodiments unsupervised learning algorithms are also used.
c. StreamAlive 207 software updates the model regularly to ensure the model stays up to date,

StreamAlive 207 software builds a livestream engagement (hereafter LSE) model, to determine the flow of engagement throughout the entirety of a livestream, based on sets of historical livestream data.

The StreamAlive 207 software uses the EP model in real time on the comments data to identify the pattern of engagement. The program compares the output of the EP model with the flow of engagement from the LSE model to determine whether any action is required.

If an action is required, the StreamAlive 207 software uses the output of the EP model to provide feedback to the user of a specified recommendation. This is done by the StreamAlive 207 software by:
a. Converting the specified recommendation from text to voice.
b. Sending the voice clip to the front end to be played on the StreamAlive 207 app in the browser or in the StreamAlive 207 mobile app, which the user can hear in their headsets/earphones.

Further, the StreamAlive 207 software mobile app will display the specified recommendation as a text and as a voice.

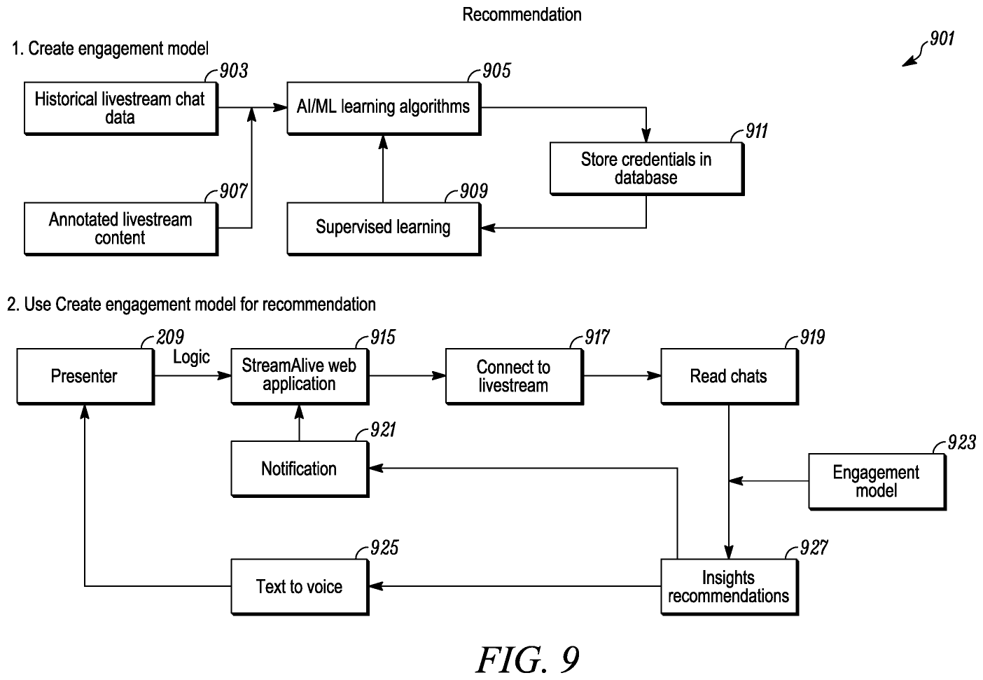

FIG. 9 illustrates a block diagram for an engagement and recommendation model 901. The initial step is creating and engagement model for this AI/ML learning algorithms 905 are employed in this particularly supervised learning 909 is preferred. The AI/ML learning algorithms 905 accept as input historical livestream chat data 903 and annotated livestream content 907 and train the model whose credentials are stored in a database 911. The supervised learning 909 enables the stored credentials 911 to be fed back to the AI/ML learning algorithm.

Further in FIG. 9 an engagement model for recommendation is provided where the presenter 209 provides logic to the StreamAlive web application 915 which connects to the livestream 917 and reads chats 919 and based on engagement model 923 recommends insights 927. A notification 921 to StreamAlive web application 915 is provided by the insight recommendations 927 and as text to voice 925 input to the presenter 209.

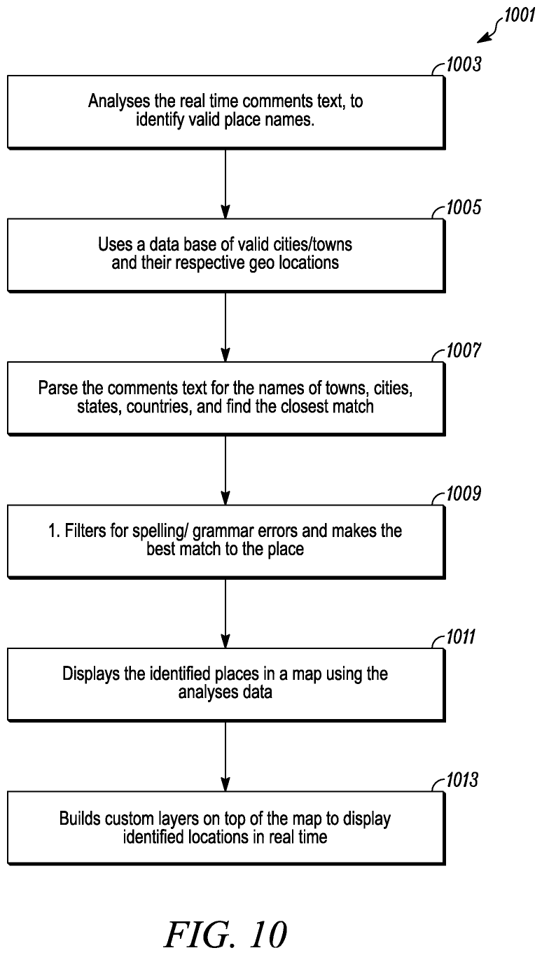

Referring now to FIG. 10, an engage module 1001 of the present invention that provides engagement tools to the host for engaging the audience.

The StreamAlive 207 software takes the comments data from the read module, processes it as per the required engagement tool, and renders it as a visualization that the presenter 209 can share with the audience to engage them by showing a visual representation of their inputs in real time. In effect, these tools in the engage module will facilitate engagement at scale with a large audience by intelligently using audience comments as audience inputs. This is a unique approach as most engagement modules currently deployed (e.g., polls) require audiences to go to third party apps and website to participate and provide their inputs. StreamAlive 207 has a unique approach and the technology is frictionless as it works with the comments data that is native to the livestreaming platform.

Some of the engagement tools are Maps, Word Cloud, Polls, Q&A, and. Games:

Maps when activated, displays the location of the audience member(s) on a world, continent, country, state or city map. This visualization will also feature a real-time display of the latest participant/commenter (username and place) to help the user acknowledge/engage with each and every participant/audience member.

The Stream Alive 207 software analyzes the real time comments text, to identify valid place names 1003. Then Stream Alive 207 software attaches geo-location (latitude and longitude) data to the identified places. This is done by:
a. Using a database of valid cities/towns and their respective geo-locations 1005.
b. Parsing the comments text for the names of towns, cities, states, countries, and
c. Finding the closest match in the places data base 1007.

In parsing comments text for names of places, the Stream Alive 207 software filters spelling/grammar errors and makes the best match to the place database 1009. This analysis and the display thereof, is in real-time and at scale.

The Stream Alive 207 software displays the identified places in a world map using the analyzed data 1011. This is done by using MapBox software. In other embodiments, other tools may be used to display the world/country map in the Stream Alive 207 software.

The Stream Alive 207 software builds custom layers on top of the map to display identified locations in real time 1013. At the same time, the custom layers are built with user experience in mind. In other embodiments a visual indication is provided on the map to indicate the number of audience members from a particular city.

The Stream Alive 207 software displays a prominent call out of the latest participant/commenter and their location from, at the top of the screen.

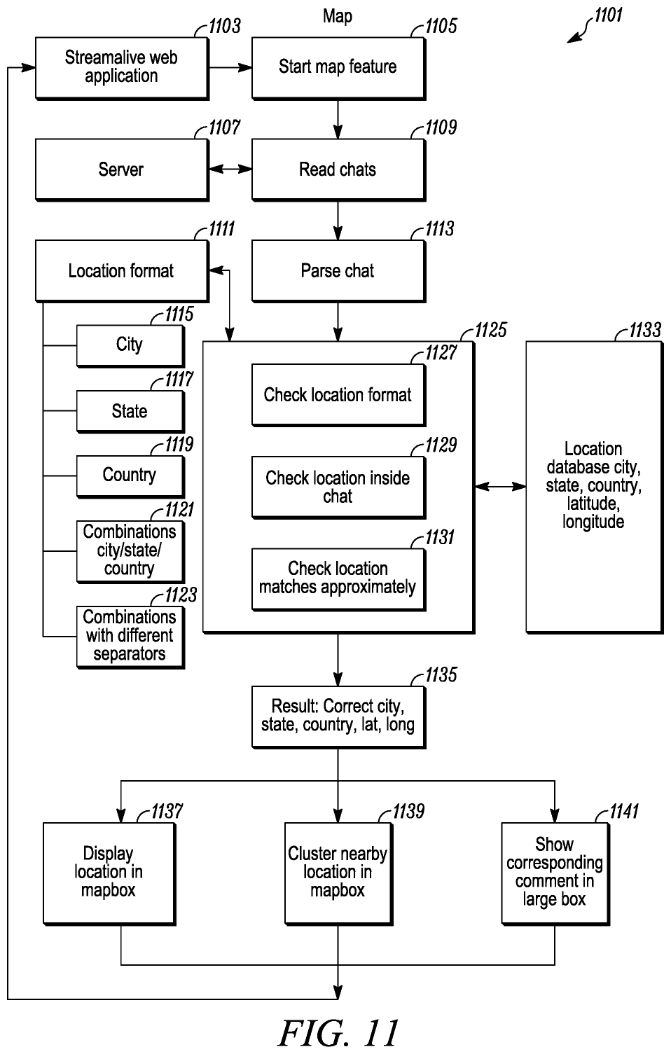

FIG. 11 illustrates an operation of a map model feature 1101. The StreamAlive web application 1103 initiates map feature 1105 which reads chats 1109 from the server 1107 and parses the chat 1113.

On parsing the chat 1113, imprecise chat inputs are handled by a location check module 1125 by checking location format 1127, checking location inside chat input 1129 and further making a location match approximately 1131. The location check module 1125 interfaces with the location database 1133 in an embodiment, tracks but not limited to the city, state, country, latitude, and longitude.

The location check module 1125 tags the output in a location format 1111 which comprises city 1115, state 1117, Country 1119. Further various combinations of city, state and country 1121 and also the said combinations with different separators 1123 are used.

Further the location check module 1125 outputs the result as correct city, state, country, latitude and longitude 1135. The said output 1135 in some embodiments may be displayed in a MapBox 1137, can cause clustering in nearby location in MapBox 1139 and may show corresponding comment in large box 1141 which is further fed to the StreamAlive web application 1103.

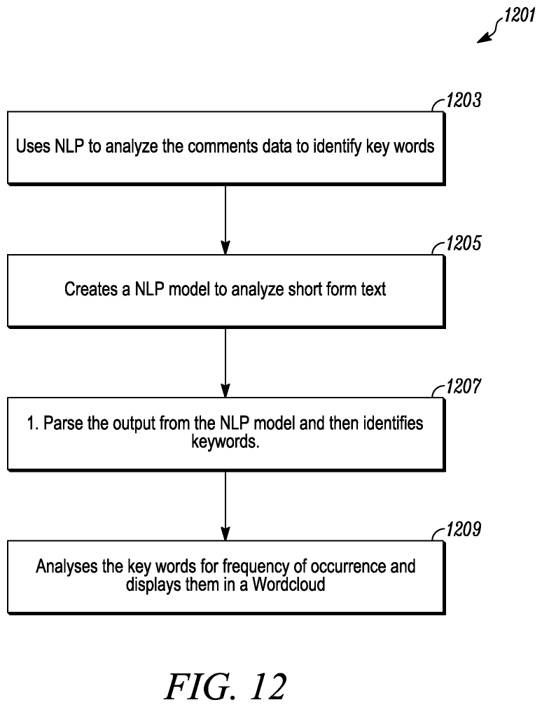

FIG. 12 illustrates a keyword analysis module that enables the StreamAlive 209 software to use NLP to analyze the comments data to identify keywords 1203. Also, an NLP model is created to analyze short form text 1205

Further the output from the NLP model is parsed and the keywords are identified 1207. The keyword output is analyzed for frequency of occurrence and then displayed in a word cloud 1209.

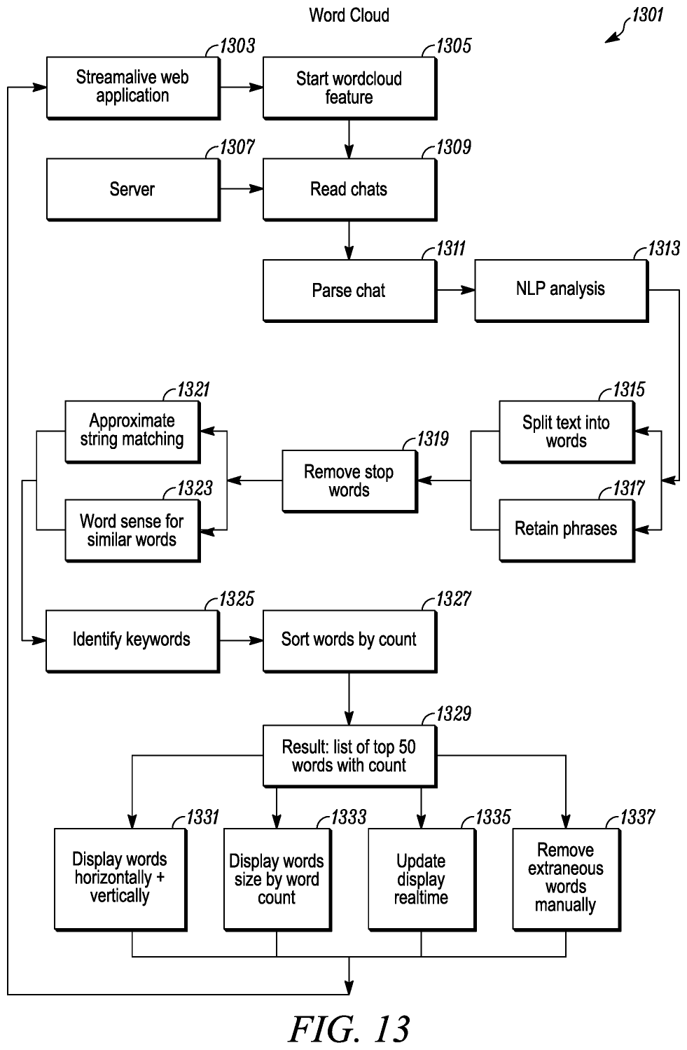

FIG. 13 illustrates an operation of the keyword model which ultimately leads to the display of the word cloud 1301. The StreamAlive web application 1303 initiates the word cloud feature 1305. The said feature 1305 reads chats 1309 from the server 1207. The input chats are parsed 1311and further NLP analysis is performed on it 1313.

The out put of NLP analysis 1313 is simultaneously split into words 1315 while retaining certain phrases 1317. Further the resulting output is stripped of stop words 1319 which is input two kinds of text processing.

In a first string-processing stage an approximate string matching is performed 1321 also parallelly a word sense matching for similar words 1323 is performed. From the previous stage key words are extracted 1325. Further the keywords are sorted by word count statistics 1327.

The output result is the top 50 keywords of the most frequent occurrence 1329. While displaying keywords in some embodiments several techniques may be adopted. For example:
a. The words may be displayed horizontally and vertically 1331.
b. The word size may be proportional to the word count 1333
c. The display may be updated real-time 1335 as the audience chat is input.
d. Also, some extraneous words may be removed manually 1337.

This entire process is managed by the StreamAlive web application 1303.

Polls display responses to a poll in the form of a dynamic bar chart in some embodiments with either preset options or with free form options. In other embodiments pie charts (or other charts) may be used to indicate polls.

With preset options the host sets up poll questions and poll options in settings before the livestream. The StreamAlive 209 software uses NLP to analyze the comments data to identify poll options based on pre-set values. This is done by:
a. An NLP model to analyze short form text.
b. The StreamAlive 209 software parses the output from the NLP model and then to identify poll options.
c. Displaying the results of the poll options as a bar chart in real time
d. With Free form, he StreamAlive 209 software uses NLP to analyze the comments data to identify poll options without any preset values. This is done by:
   i. An NLP model to analyze short form text
   ii. The StreamAlive 209 software to parse the output from the NLP model and then to identify keywords.
e. Displaying the results of identified keywords as a bar chart in real time

Q&A displays direct answers to questions as a word cloud or grouped text and allows the host to use rules and algorithms to triage questions asked during the livestream into a separate list that can be addressed collectively when needed.

The StreamAlive 209 software uses NLP to analyze the comments data to identify questions by participants/commenters/audience members in free form. This is done by:
a. An NLP model to analyze short form text.
b. The StreamAlive 209 software to parse the output from the NLP model and then to identify questions, compare the identified questions and group them based on similarity.
c. Alternatively, questions could be identified based on predefined rules and syntaxes that have been communicated to the audience. For example, asking attendees to prefix all questions with “Q:” allows the StreamAlive 209 software to specifically look for this prefix to identify a question.
d. Displaying the identified and grouped questions as a list, in real time. The display will be sorted as per importance based on frequency of occurrence/relevance, etc.

The StreamAlive 209 software also has an option to link predefined answers to the identified grouped questions and display them. The StreamAlive 209 software will build a bot to display in the comments stream, in real time, a link to the predefined answer for a particular question.

Over time, the StreamAlive 209 software will build a knowledge base of common questions asked by the audience across multiple livestream sessions. The host can preset up answers to the common questions for the bot to link and display in real time during a livestream.

Games provide an interactive session with the audience or by audience with a simple graphic display that allows comments to translate into inputs for gameplay so the audience can collectively play a simple game that gives a feeling of being connected to each other towards a common goal in a game. This is especially relevant during breaks - to keep audiences engaged and entertained.

When the host prompts the audience to play a game and provides the simple rules of the game to the audience, the software will analyze the comments for an action to take place as a graphic display (e.g., more audience members typing “left” will move the worm to the left or more audience members typing “tall hat” will place a tall hat on a mannequin). This is done by:
a. The StreamAlive 209 software for a set of games, each with its own rules, objectives, etc.
b. Analyzing comments for frequency of an action in real time and
c. By taking into account the audience input by the StreamAlive 209 software and using that action to move the gameplay forward towards the game's objective.

In other embodiments simple but powerful game is wordplay like anagrams. These lend themselves perfectly to comments. A person solving an anagram correctly (enter answer in comments) is acknowledged with an automatic kudos in the screen. The games are not limited to the above-mentioned ones, other games can be used for enhancing audience engagement.

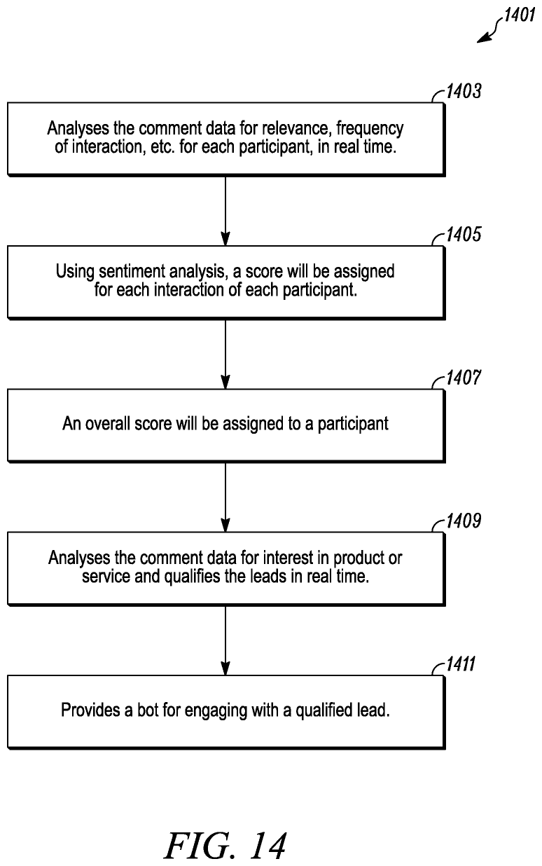

Referring now to FIG. 14, a convert module of the present invention that monetizes the audience data by converting leads to customers using analytics and signals from audience engagement.

The convert module uses the data from read module, the StreamAlive 209 Software runs various analyses of audience interaction to help the host in filtering, conversion, or monetization by:
a. Lead scoring and Lead qualification,
b. Customer moments of truth, and
c. Customer analytics for future sales.
d. Lead scoring and Lead qualification:

The StreamAlive 209 software analyzes the comment data for relevance, frequency of interaction, etc. for each participant, in real time 1403, in other embodiments more parameters are used for analysis. Using sentiment analysis, a score will be assigned for each interaction of each audience member 1405. Then an overall score will be assigned to the audience member 1407 during the livestream.

The StreamAlive 209 software analyzes the comment data for interest in product or service and qualifies the leads in real time 1409.

The StreamAlive 209 software provides a bot for engaging with a qualified lead 1411.

For customer moments of truth, the StreamAlive 209 software analyzes the comment data for relevant interaction, etc. for each audience member in real time. Using sentiment analysis and an AI model, StreamAlive 209 software can identify audience members with positive or negative moments of truth, during the livestream. (e.g., an audience member makes negative comments about the product/service and continues with multiple comments of a similar nature, but without any response or engagement from the host/user/presenter this creates a negative moment of truth for the audience).

Customer analytics for future sales:
a. Post livestream analysis for list of participants identified as potential customers.
b. Keyword matching:
c. Keyword matching-finding audience members who used certain words or phrases.

The StreamAlive 209 software analyzes comments data for specific keywords and generates a list of usernames related to the specific keywords.

In rules based filtering the host defines various criteria, and the StreamAlive 209 software applies them as filters to figure audience members who meet the criteria. For example, if a question was asked “How soon would you like to sign up for a public speaking class?”, and three choices were provided: “1. ASAP 2. In the next 3 months, 3. Don't know”, the livestreamer will have the ability to (for example) filter out the attendees who said “1. ASAP”—since that is an intent signal cueing immediacy.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A method of engaging an audience in a livestreaming session comprising:
aggregating the audience's data in the livestream session.
processing the audience's data; and
recommending interventions during the livestream session to a host based on the audience's data.

2. The method of claim 1, wherein the audience's data include the audience's comments during the livestream session.

3. The method of claim 2, wherein comments include at least one of a location, questions, agreements, support, answers, appreciation, condemnation, opinion, requests, or doubt.

4. The method of claim 1, wherein recommending intervention comprising:
analyzing the audience's data for engagement patterns;
sending feedback to the host, feedback includes recommendations to take an action based on the engagement patterns; and
engaging the audience based on the feedback.

5. The method of claim 4, wherein engaging further comprising:
providing access to at least an engagement tool to the host; and
sharing the engagement tool with the audience.

6. The method of claim 5, wherein the engagement tools render visualization of audience data in real time.

7. The method of claim 6, wherein audience's data include location of the audience.

8. The method of claim 7, wherein the visualization includes displaying the location, on the map, the location is typed by at least one of the audience members during the livestream session.

9. The method of claim 4, wherein engagement pattern further comprising:
using historical comments data including comment, text, emojis, username, timestamp for each engagement Pattern (EP) model to identify a pattern; and
using supervised learning algorithm to inform the model on the pattern of engagement.

10. The method of claim 6, wherein audience data includes audience's comment in response of host's query.

11. The method of claim 10, wherein audience comments reflect audience mood.

12. The method of claim 11, wherein visualization includes displaying word cloud of audience's comments.

13. The method of claim 12, further comprising analyzing the comments data to identify key word.

14. The method of claim 13, further comprising:
parsing output from an NLP model to identify keywords; and
analyzing the key words for frequency of occurrence and displaying them in a word cloud.

15. A system of engaging audience in a livestreaming session comprising:
a processor; and
a memory communicatively coupled to the processor, wherein the memory stores processor instructions, which, on execution, causes the processor to:
aggregate audience's data in the livestream session;
process the audience's data; and
recommend interventions during the livestream session to a host based on the audiences' data.

16. The system of claim 15, wherein the audience's data include the audience's comments during the livestream session.

17. The system of claim 16, wherein comments include at least one of a location, questions, agreements, support, answers, appreciation, condemnation, opinion, requests, or doubt.

18. The system of claim 15, wherein recommend interventions comprising:
analyzing the audience's data for engagement patterns;
sending feedback to the host, feedback includes recommendations to take an action based on the engagement patterns; and
engaging the audience based on the feedback.

19. The system of claim 18, wherein engaging further comprising:
providing access to at least an engagement tool to the host; and
sharing the engagement tool with the audience.

20. The system of claim 19, wherein the engagement tools render visualization of audience data in real time.
